(19) United States
(12) Patent Application Publication
(10) Pub. No.: US 2024/0034591 A1
(43) Pub. Date: Feb. 1, 2024

(54) SEPARATING DEVICE AND METHOD FOR REGIONALLY SEPARATING A FILM WEB

(71) Applicant: SCHOBERTECHNOLOGIES GMBH, Eberdingen (DE)

(72) Inventors: Ralf-Hendrik BORN, Vaihingen/Enz (DE); Gerald GLAAS, Vaihingen/Enz (DE); Rene KOSTEWA, Mainhardt (DE); Uwe SCHWEIZER, Mühlacker (DE)

(21) Appl. No.: 18/257,860

(22) PCT Filed: Nov. 23, 2021
(86) PCT No.: PCT/EP2021/082673

§ 371 Date: Jun. 15, 2023

(30) Foreign Application Priority Data
Dec. 17, 2020 (DE) 10 2020 134 021.4

(51) Int. Cl. B65H 35/08

(52) U.S. Cl. CPC B65H 35/08; B65H 2301/4493; B65H 2301/515323; B65H 2402/32

(57) ABSTRACT

Separator for separating a film web region by region, having an anvil plate which has a working surface for laying out an end region of a film web, a conveyor which is mounted such that it can be moved linearly with respect to the anvil plate along a conveying axis and which is designed to carry out a laying-out movement for the end region of the film web, the laying-out movement being aligned parallel to the working surface, and a cutting unit which has at least one cutting edge for carrying out a separating operation for an end region of the film web received between the cutting edge and the working surface. The conveyor and the cutting alternately carry out the lay out movement and the separating operation for the end region of the film web.

The invention relates to a separator and a method for separating a film web area by area.

DE 10 2015 010 251 A1 discloses a method and a device for processing and finishing, in particular punching, cutting, embossing, creasing and sealing, a continuous material web with recurring, different format lengths, the device comprising at least one rotary tool device, with which the material web undergoes processing, and web-guiding components, and at least one roll of the tool device having a larger circumference than the maximum format length of the material web to be processed.

### SUMMARY OF THE INVENTION

The invention is based on the task of creating a separator which makes it possible to separate even thin and thus unstable film webs.

This task is solved with a separator for the area-wise separation of a film web. Here, the separator comprises an anvil plate, which has a working surface for laying out an end region of a film web, a conveyor, which is mounted along a conveying axis so as to be linearly movable relative to the anvil plate and which is designed to carry out a laying-out movement, aligned parallel to the working surface, for the end region of the film web, and a cutting unit which has at least one cutter for carrying out a separating operation for an end region of the film web received between the cutter and the working surface, the conveyor and the cutting unit being designed for alternately carrying out the lay out movement and the separating operation for the end region of the film web.

The task of the conveyor is to lay out a film web, which can be removed from a deposit magazine or which can be unwound from a supply roll, on the working surface of the anvil plate in such a way that, in a subsequent working step, a separating operation for an end region of the film web can be carried out with the aid of the cutting unit. In this case, it is provided that a leading edge of the end region of the film web laid out on the working surface by the conveyor comes to rest at a defined position along the extension of the working surface in the direction of the conveying axis. Particularly preferably, it is provided that this position is always constant for a given cutting unit.

Exemplarily, it is provided that a length of the film web may be in a range from several meters to several 100 meters, while a width of the film web is in a range from a few centimeters to several decimeters, and that a thickness of the film web is in a range from fractions of a millimeter to several millimeters. The film web can optionally be made of a single material, in particular a plastic material, or as a multilayer arrangement of films formed in particular from different materials such as plastic or metal.

By alternately carrying out the lay out movement and the separating operation for the end region of the film web, as performed by the conveyor and the cutting unit, the film web performs a stepwise movement along the conveying axis, whereby a pick-up of separated sections of the film web can be performed while the film web is stationary, which is particularly advantageous for the handling of films with a small thickness.

In principle, it is provided that the anvil plate is fixedly received on a machine frame and a relative movement of the conveyor and the cutting unit with respect to the anvil plate is performed for carrying out the conveying operation and the separating operation.

In an alternative embodiment, it is provided that the conveyor and the cutting unit are held stationary on the machine frame and that the anvil plate performs a linear, intermittent and cyclically recurring relative movement parallel to the conveying axis with respect to the conveyor and the separator. In this case, it can be provided in particular that a deposit magazine associated with the anvil plate for a sheet-like converted film web or a supply roll associated with the anvil plate with a wound-up film web is moved with the anvil plate.

In any case, it may be provided that the conveyor and/or the cutting unit, in addition to a linear relative movement along the conveying axis with respect to the anvil plate, have at least one further degree of freedom of movement, for example a rotational degree of freedom of movement or a linear degree of freedom of movement oriented transversely to the conveying axis.

Advantageous further embodiments of the invention are the subject of the subclaims.

It is expedient for the conveyor, in a first conveying position, to assume a first, minimum distance relative to a front edge of the anvil plate aligned transversely to the conveying axis and, in a second conveying position, to assume a second, maximum distance relative to the front edge, and for the cutting unit, in a rest position, to assume a third, maximum distance relative to the front edge and, in a working position, to assume a fourth, minimum working distance relative to the front edge. In this case, the second distance is selected to be greater than the fourth distance, so that overlapping of a working area of the conveyor and a working area of the cutting unit is ensured. A difference between the first, minimum distance for the conveyor relative to the front edge of the anvil plate and the second, maximum distance describes the maximum working stroke that the conveyor can perform along the conveying axis. Depending on the design of the cutting unit, this maximum working stroke can be fully or only partially utilized for the movement of the conveyor. A difference between the third, maximum distance for the cutting unit relative to the front edge of the anvil plate and the fourth, minimum distance describes the maximum working stroke that the separator can perform along the conveying axis. The extent to which this maximum working stroke is fully or only partially utilized depends on the design of the at least one cutting edge of the cutting unit. Since the second distance which the conveyor can assume relative to the front edge of the anvil plate is chosen to be greater than the fourth distance which the cutting unit can assume relative to the front edge of the anvil plate, it is ensured that the separator can always process an end region of the film web laid out by the conveyor on the working surface of the anvil plate. Particularly preferably, it is provided that movements of the conveyor and the cutting unit in the same direction along the conveying axis take place synchronously in order to ensure the fastest possible processing of the end region of the film web.

In a further development of the invention, it is provided that the conveyor has a transport cylinder with a transport cylinder axis aligned transversely to the conveying axis and parallel to the working surface, which transport cylinder is designed for carrying out the conveying operation with a linear movement along the conveying axis and/or with a rotational movement about the transport cylinder axis. The task of the transport cylinder is to temporarily pick up the end region of the film web and to exert a pulling force on the film web directed in the direction of the conveying axis in order to pull the film web out of a deposit magazine or to unwind it from a supply roll. For this purpose, the transport cylinder can be equipped with a clamping device, in particular with a gripper bar or a plurality of grippers, for fixing the end region of the film web. In order to carry out the relative movement for the transport cylinder with respect to the anvil plate, it is provided that the transport cylinder is assigned a drive which is designed to initiate a linear movement parallel to the conveying axis and to initiate a rotational movement about the transport cylinder axis. Such a drive can be realized, for example, as an arrangement of a hydraulic cylinder for the linear movement and a gear transmission for the rotational movement of the transport cylinder. Preferably, it is provided that both for the provision of the linear movement and for the provision of the rotational movement of the transport cylinder, individually controllable drives are provided in each case, in particular electric servo drives, which can be controlled by a controller as a function of the desired working stroke and as a function of the desired rotational movement for the transport cylinder.

In a further embodiment of the invention, it is provided that the cutting unit comprises a cutting cylinder having a cutting cylinder axis aligned transversely to the conveying axis and parallel to the working surface, which cutting cylinder axis is configured for performing the cutting operation with a superposition of a linear movement along the conveying axis and a rotational movement about the cutting cylinder axis, wherein the at least one cutting edge is attached to an outer surface of the cutting cylinder. The task of the cutting cylinder is to either completely cut off the end region of the film web from the rest of the film web or to cut out sections of the film web. For this purpose, the cutting cylinder has at least one cutting edge, but can also be provided with a plurality of differently shaped cutting edges in order to be able to cut off even complex geometries from the end region of the film web and/or to be able to cut out sections from the end region of the film web. In addition or alternatively, the cutting cylinder can also be equipped with an embossing tool and/or a creasing tool.

Exemplarily, it is provided that the cutting cylinder is the only format part of the cutting device, i.e. the only component of the cutting device that can be replaced in case of a change of the component to be cut off from the end region of the film web or to be cut out from the end region of the film web.

In order to minimize the effort required to adapt the cutting cylinder when the component is changed, the cutting cylinder can have a dimensionally stable support cylinder provided with permanent magnets and/or electromagnets and cutting plates and/or creasing plates and/or embossing plates applied thereto, which enable a rapid format change. For this purpose, it can be provided in particular that at least one positioning device, in particular in the form of a locating pin, is provided on the carrier cylinder in order to ensure exact positioning of the exchangeable cutting plates and/or creasing plates and/or embossing plates.

In order to carry out the relative movement for the cutting cylinder with respect to the anvil plate, it is provided that the cutting cylinder is assigned a drive which is designed to initiate a linear movement parallel to the conveying axis and to initiate a rotational movement about the cutting cylinder axis. Such a drive can be realized, for example, as an arrangement of a hydraulic cylinder for the linear movement and a gear transmission for the rotational movement of the cutting cylinder. Preferably, it is provided that both for the provision of the linear movement and for the provision of the rotational movement of the cutting cylinder, individually controllable drives are provided in each case, in particular electric servo drives, which can be controlled by a controller as a function of the desired working stroke and as a function of the desired rotational movement for the cutting cylinder.

It is preferably provided that the working surface has a flat, in particular rectangular, support region for the end region of the film web as well as bearing strips adjoining the support region on both sides and extending along the conveying axis as well as projecting from the support region in a raised manner, and that the cutting cylinder rests with an outer surface on the bearing strips at least in certain regions when the movement between the rest position and the working position is carried out. The bearing strips, which are aligned on the edge of the working surface in each case with a longest edge parallel to the conveying axis, are used for a rolling movement of the cutting cylinder during the relative movement of the cutting cylinder with respect to the anvil plate. Due to the geometry of the bearing strips, whose upper sides are aligned parallel to each other and with the first acute angle to the working surface, in interaction with the cone sections formed on the outer circumferential surface of the cutting cylinder, flat supports are produced between the cutting cylinder and the bearing strips in each case. Preferably, the extension of the cone sections in the direction of the cutting cylinder axis is greater than the extension of the upper sides of the bearing strips in the direction of the cutting cylinder axis. Depending on a lateral positioning of the cutting cylinder relative to the bearing strips, a distance of the cutting cylinder axis relative to the working surface can thus be adjusted. Preferably, a suspension of the cutting cylinder is provided to allow a change in position for the cutting cylinder along the cutting cylinder axis to allow an adjustment of the resulting distance between the cutting cylinder axis and the working surface. The cone sections of the cutting cylinder can also be designed as replaceable races, for example in order to be able to ensure continued use of the cutting cylinder after replacement of the races in the event of wear.

In an alternative embodiment, it is provided that the bearing strips are designed to be replaceable and that the cutting cylinder is circular-cylindrical in those areas of its outer circumferential surface that are intended to rest on the upper side of the bearing strips. Accordingly, an adjustment of a distance between the cutting cylinder axis and the working surface is effected here by the exchange of the bearing strips without having to provide a lateral adjustment possibility for the cutting cylinder.

It is advantageous if a sensor is assigned to the transport cylinder, which is designed to detect a front edge of the end region of the film web, in particular in the first conveying position, and/or that a sensor is assigned to the cutting cylinder for detecting a position of the cutting edge, in particular in the rest position, and/or that a sensor is arranged in the region of the front edge of the anvil plate for detecting properties of the film web.

The sensor assigned to the transport cylinder, in conjunction with a suitable evaluation device for evaluating the sensor signal, thus has the task of enabling a statement to be made as to whether the length of the end region of the film web wound onto the transport cylinder is sufficient. If this is not the case, measures must be taken, in particular by rotating the transport cylinder, to correct the length of the end section of the film web wound onto the transport cylinder to a predetermined dimension before the lay out movement, which is then performed by the transport cylinder, is carried out. The sensor associated with the transport cylinder may be stationary on the machine frame to enable detection of the end edge of the end region of the film web in the first conveying position. Alternatively, it may be provided that the sensor is connected to the transport cylinder in such a way that it is carried along during a linear movement of the transport cylinder.

The sensor associated with the cutting cylinder, in conjunction with a suitable evaluation device for evaluating the sensor signal, has the task of enabling a statement to be made as to whether the at least one cutting edge of the cutting cylinder is in a correct position before the cutting process is carried out. If this is not the case, the correct position of the at least one cutting edge can be adjusted by rotating the cutting cylinder, for example. The sensor associated with the cutting cylinder can be arranged stationary on the machine frame in order to monitor the position of the at least one cutting edge in the rest position of the transport cylinder. Alternatively, it can be provided that the sensor is arranged on a drive for the cutting cylinder and can perform a detection of the position of the at least one cutting edge during a relative movement of the cutting cylinder with respect to the anvil plate.

In the region of the front edge of the anvil plate 6 and thus in a region between a deposit magazine for a sheet-like converted film web or a supply roll assigned to the anvil plate with a wound-up film web and the anvil plate, a sensor can be arranged with which a detection of properties of the film web is carried out. For example, this sensor can be used to detect defects in the film web.

It is advantageous if at least one mouth opening of a fluid channel is formed on the working surface and/or on an outer surface of the conveyor and/or on an outer surface of the cutting unit, which mouth opening is designed to provide a negative pressure or a pressurized fluid. It is advantageous if the working surface is provided, at least in some areas, with a plurality of mouth openings of the at least one fluid channel which are arranged, in particular in a matrix with uniform pitch, to be able to effect reliable adhesion of the end region of the film web after the end region of the film web has been laid out by applying negative pressure to the mouth openings of the fluid channel. The at least one fluid channel is connected to a vacuum supply and/or to a fluid source, in particular a compressed air source. By means of a valve unit arranged between the vacuum supply or the fluid source and the fluid channel, influence can be exerted on a negative pressure or positive pressure at the respective mouth openings in the working surface. If necessary, it can be provided that several fluid channels formed separately from one another are provided in the anvil plate, each with associated mouth openings, in order to be able to supply different areas of the working surface with negative pressure or compressed air in different ways. The mouth openings of the fluid channel can be formed, for example, by bores which are aligned transversely to the working surface of the anvil plate. Where appropriate, it is envisaged to realize at least part of the mouth openings by means of a porous design of a portion of the anvil plate, this can be achieved, for example, by using a plate of a metal sintering material which is inserted into a suitable recess in the anvil plate and communicates with one or more fluid channels. The advantage of such a design of at least a partial area of the anvil plate is that both a vacuum suction and a blow-off of the film web and also a separation process for the end area of the film web can be carried out there.

The mouth openings of the at least one fluid channel provided on the outer surface of the conveyor, which may in particular be the transport cylinder or a transport beam adjustable in linear motion parallel to the working surface, are used in particular for a vacuum suction of the end region of the film web, for example in order to be able to exert tensile forces on the film webs. The at least one fluid channel of the conveyor is connected to a vacuum supply and/or to a compressed air source with the interposition of a valve unit. Exemplarily, it can be provided that the mouth openings of the at least one fluid channel are arranged over at least a partial area of the outer surface, in particular over the entire width of the conveyor, or over the entire outer surface of the conveyor.

The mouth openings of the at least one fluid channel provided on the outer surface of the cutting unit, which may in particular be a cutting cylinder, are used in particular for a vacuum suction of sections or cutouts of the film web during the execution and/or after the execution of the separating operation and thus enable, for example, controlled removal of cut-out regions of the film web or cut-off waste pieces of the film web. The at least one fluid channel of the cutting unit is connected to a vacuum supply and/or to a compressed air source with the interposition of a valve unit. In an advantageous further embodiment of the invention, it is provided that the at least one cutting edge of the cutting unit and the working surface of the anvil plate are designed for carrying out a separating operation for the end region of the film web from the group: transverse cutting of the film web, cutting out of film cutouts from the film web, crush cutting, lifting punching, shear cutting.

In a further embodiment of the invention, it is provided that the cutting unit is designed as a lifting punch for carrying out a lifting punching movement aligned transversely to the working surface of the anvil plate and is mounted so as to be linearly movable relative to the anvil plate between a rest position at a distance which is greater than an extension of the transport device transversely to the working surface and a working position at a disappearing distance from the working surface.

It is advantageous if a gripper is arranged on the anvil plate so as to be relatively movable for a removal of good parts to a defined deposit position and/or for a removal of waste. The task of the gripper is in particular to remove the good parts cut out of the end region of the film web or to remove the good parts cut off from the end region of the film web in a manner in which undesirable deformation can be avoided even in the case of a very small thickness of the good parts. Furthermore, the gripper is designed to place the good parts in a defined manner, in particular as flat as possible and with a predefinable orientation, either on a stack of good parts or to feed them directly to a subsequent processing operation for the good parts. For example, it can be provided that several separators are spatially arranged in such a way that the respective grippers feed differently configured good parts to a centrally arranged processing device, which can be a film sealing device, for example, so that direct further processing of the good parts provided by the respective separator can be carried out. Preferably, a sensor, in particular a camera with image processing, is assigned to the gripper in order to carry out a quality control for the parts cut out of the film web or cut off from the film web and to be able to qualify them either as good parts or as rejects and to initiate a corresponding gripper movement.

The task of the invention is solved by a method for separating a film web region by region, comprising the following steps: Grasping an end region of a film web, which is laid out on a working surface of an anvil plate, with a transport cylinder, performing a first winding movement for the end region of the film web onto the transport cylinder during a first linear retraction movement of the transport cylinder, detecting an end edge of the end region of the film web, which is arranged on the transport cylinder, with a sensor, and controlling a second winding movement for the transport cylinder at a first conveying position, at which the transport cylinder has a first, minimum distance relative to a first end region of the anvil plate, performing a combination of an unwinding movement and a second linear advancing movement for the transport cylinder along the working surface of the anvil plate for depositing the end region of the film web on the working surface, and performing a second linear retracting movement of the transport cylinder into the first conveying position, performing a combination of an unwinding movement and a third linear advancing movement for a cutting cylinder along the working surface of the anvil plate between a rest position with maximum distance from the first end portion of the anvil plate and a working position with minimum distance from the first end portion of the anvil plate, wherein a cutting edge of the cutting cylinder performs a cutting operation for an end region of the film web received between the cutting edge and the working surface, and gripping and transporting away a portion of the end region of the film web cut from the cutting edge with a gripping device movably mounted on the anvil plate.

In carrying out the process, the film web is either taken from a deposit magazine or unwound from a supply roll, the task of the transport cylinder being, in alternation with the execution of a cutting operation carried out with the cutting cylinder, in each case to lay out the end region of the film web on the working surface of the anvil plate in such a way that a sufficient length of the film web is provided for the subsequent cutting operation.

For the execution of the process, it is assumed that in a preceding work step or a preparatory work step, an end region of the film web is laid out on the working surface of the anvil plate at least in such a way that the end region can be gripped by the transport cylinder. For this purpose, provision is made in particular for at least one fluid channel in the transport cylinder, which has at least one mouth opening at the outer surface of the transport cylinder, to be subjected to negative pressure by actuating a valve unit which is connected downstream of a negative pressure supply, so that at least a partial region of the film web is sucked onto the outer surface of the transport cylinder. Supplementary or alternatively, the use of a gripping bar formed on the transport cylinder for gripping the end region of the film web can also be provided.

In a subsequent step, a first roll-up movement for the end region of the film web onto the transport cylinder takes place in the course of a linear movement of the transport cylinder in the direction of a front edge of the anvil plate.

This first roll-up movement is performed as a superposition of a rotation of the transport cylinder about the transport cylinder axis and a translation of the transport cylinder parallel to the working surface. In this case, it can be provided that the first winding movement is performed without slippage with respect to the working surface of the anvil plate, whereby exactly that length of the end region of the film web is wound onto the transport cylinder which can be accommodated by the rolling movement of the transport cylinder on the working surface of the anvil plate without the end region of the film web performing a linear relative movement with respect to the working surface. Alternatively, it can be provided that the first roll-up movement for the end region of the film web relative to the working surface of the anvil plate already takes place with slip. For this purpose, the rotational movement of the transport cylinder, which is superimposed on the linear movement of the transport cylinder, is chosen in such a way that the end region of the film web performs a linear relative movement with respect to the working surface, with tensile forces acting on the film web, which leads, for example, to an unwinding process for the film web wound on a supply roll.

While the first winding movement is being performed or after the first conveying position has been reached, the sensor associated with the transport cylinder can be used to detect whether an end edge of the end area of the film web is at a predetermined position or whether a further winding movement, also referred to as a second winding movement, is required. If the detection of the end edge of the end area of the film web reveals that the end edge is already located at the desired position, a preset value and an actual value for the control of the second rewind movement coincide, so that practically no second rewind movement is performed. If, on the other hand, there is a deviation between the specified position of the end edge and an actual position of the end edge, the second roll-up movement is carried out with feedback of a respectively updated sensor signal until the deviation disappears.

In a subsequent step, an unwinding movement for the end region of the film web is performed in order to lay out the end region of the film web on the working surface of the anvil plate in such a way that the subsequent separation process can be carried out properly. For this purpose, it is provided that the transport cylinder performs a slip-free unrolling movement relative to the working surface of the anvil plate, during which there is no linear displacement of the end region of the film web or the exertion of appreciable tensile forces on the end region of the film web. This unrolling motion is also a superposition of a rotational motion of the transport cylinder around the transport cylinder axis and a linear displacement of the transport cylinder along the working surface of the anvil plate. At the end of this unwinding movement, the end region of the film web is released from the transport cylinder, for example by switching off a vacuum supply for the fluid channel and the mouth openings connected thereto or, if necessary, by providing compressed air at the mouth openings to assist in blowing off the end region and thus removing the end region of the film web from the transport cylinder. Subsequently, the transport cylinder is transferred back to the first functional position in order to release the working surface for carrying out the separation process.

In addition, it can be provided that at least one fluid channel formed in the anvil plate is subjected to negative pressure in order to ensure that the end region of the film web is at least partially attached to the working surface and thus stabilized for carrying out the cutting operation.

The cutting operation for the end region of the film web is carried out with the aid of the cutting cylinder, which is transferred from a rest position to a working position with a slip-free unwinding movement comprising a superimposition of a rotational movement of the cutting cylinder about a cutting cylinder axis and a linear movement of the cutting cylinder along the conveying axis. At this point, the at least one cutting edge of the cutting cylinder engages the end portion of the film web and performs the desired cutting operation, which can effect a section from the end portion of the film web or a cutout from the end portion of the film web, or a combination thereof.

Depending on the geometry of the cutting cylinder and depending on the geometry of the part cut off from the end region of the film web or cut out from the end region of the film web, either a slip-free return of the cutting cylinder from the working position to the rest position takes place first before the produced part is transported away with a gripping device, or a transport of the produced part with a gripping device takes place before the cutting cylinder is returned to the rest position.

Preferably, it is provided that the gripping device comprises a sensor, in particular a camera with image processing, with the aid of which a quality control for the produced part can be carried out and only those parts which can also be qualified as good parts are supplied to a downstream processing.

Supplementary or alternatively, it can be provided that at least one fluid channel in the cutting cylinder is subjected to a negative pressure in order to transport away the produced part and/or any waste during the execution of the return movement.

In a further embodiment of the method, it may be provided that the end portion of the film web is engaged with the transport cylinder to perform a first linear feed motion for the transport cylinder along a working surface of the anvil plate for laying out the end portion of the film web on the working surface. For example, this step may be performed prior to performing the first rewinding movement to first provide a sufficient length of the end portion of the film web for performing the first rewinding movement.

Furthermore, a separator for cutting a film web region by region can be provided, which has an anvil plate with a working surface for laying out a film web and which has a conveyor for conveying the film web along a conveying axis aligned parallel to the working surface and which has a cutting cylinder which has at least one cutting edge for carrying out a cutting operation for the film web received between the cutting edge and the working surface, wherein bearing strips are arranged at the edges of the working surface, each with a longest edge aligned parallel to the conveying axis, which bearing strips have upper sides aligned parallel to one another and at a first acute angle to the working surface, and wherein the cutting cylinder has two cone sections on an outer circumferential surface, which cone sections are aligned at a second acute angle to a cutting cylinder axis and are designed to rest on the upper sides, wherein an adjusting unit is formed between the anvil plate and the cutting cylinder for positioning the cutting cylinder along the cutting cylinder axis.

Such a separator enables a distance adjustment between the working surface and the at least one cutting edge of the cutting cylinder by a movement of the cutting cylinder along the cutting cylinder axis, since due to the wedge effect of the upper sides of the bearing strips in connection with the cone sections a superimposed linear movement for the cutting cylinder is caused thereby, with which a distance between the cutting cylinder axis and the working surface is influenced.

Such an embodiment of the bearing strips and the cutting cylinder can also be provided for the separator as described above.

### BRIEF DESCRIPTION OF THE DRAWINGS

An advantageous embodiment of the invention is shown in the drawing. Here shows:

FIG. 1 a side view of a separator with a conveyor, an anvil plate and a cutting unit,

FIG. 2 a sectional enlargement of the separator according to FIG. 1 with some detailed illustrations,

FIG. 3 a top view of a film web which has been processed with the separator according to FIGS. 1 and 2,

FIG. 4 a schematic representation of the conveyor and the cutting unit as well as the film web during a first working step,

FIG. 5 a second working step for the conveyor and the cutting unit,

FIG. 6 a third working step for the conveyor and the cutting unit,

FIG. 7 a fourth working step for the conveyor and the cutting unit,

FIG. 8 a fifth working step for the conveyor and the cutting unit,

FIG. 9 a sixth working step for the conveyor and the cutting unit, and

FIG. 10 a front view of the anvil plate provided with bearing strips and the cutting cylinder matched thereto.

### DETAILED DESCRIPTION OF THE INVENTION

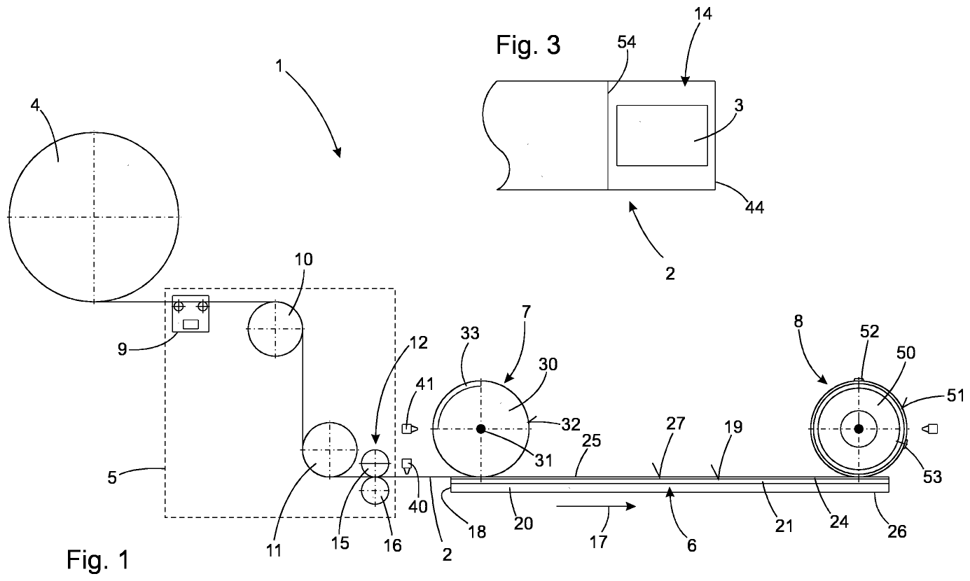

A separator 1 shown only schematically and not to scale in FIG. 1 is used for processing a film web 2 which is to be separated into individual, purely exemplary rectangular cutouts, as shown schematically in FIG. 3.

Here, the separator 1 comprises a material roll 4, on which the film web 2 is wound, a feed device 5, which is designed to support an unwinding movement for the film web 2 from the material roll 4, an anvil plate 6 for supporting the film web 2, a conveyor 7 and a cutting unit 8.

The material roll 4, the feed device 5 and the anvil plate 6 are arranged, purely by way of example, on a common machine frame which is not shown. The conveyor 7 and the cutting unit 8 are likewise arranged on the machine frame in a manner not shown so as to be movable relative to the anvil plate 6, wherein drives not shown in greater detail, for example hydraulic cylinders, pneumatic cylinders, hydraulic motors, pneumatic motors, electric servomotors and combinations thereof, can be used for a relative movement of the conveyor 7 and the cutting unit 8 with respect to the anvil plate 6.

The material roll 4 is configured to provide the film web 2, wherein a length of the film web 2 wound on the material roll 4 is many times greater than a length of the anvil plate 6, so that a plurality of cutouts 3 can be cut out of the film web 2 before a change of the material roll 4 is required.

The feed device 5 arranged adjacent to the material selection 4 comprises, purely by way of example, a side edge control 9, a first deflection roller 10, a second deflection roller 11 and a pair of conveying rollers 12. The task of the side edge control 9, which scans a side edge of the film web 2 during a conveying movement of the film web 2 by means of a sensor not shown in more detail, is to ensure a central arrangement of the film web 2 on the first deflection roller 10. For this purpose, the side edge control 9 can influence the alignment of the film web 2 relative to the first deflection roller 10 via an actuator that is also not shown. After passing the first deflection roller 10 and the second deflection roller 11, the film web 2 is guided through between two conveying rollers 15, 16 of the pair of conveying rollers 12, wherein at least one of the two conveying rollers 15, 16 can be driven in order to support a movement of the film web 2 in the conveying direction 17 shown schematically, which can be regarded as a direction vector of a conveying axis.

As will be explained in more detail below, discontinuous conveying is provided for the film web 2, since the processing of the film web 2 on the anvil plate 6 is also performed discontinuously.

Exemplarily, it is provided that in an area between the pair of conveying rollers 12 and a leading edge 18 of the anvil plate 6, a first sensor 40 is arranged above the film web 2, which is used to scan the film web 2 and can detect properties of the film web such as a film type, preferably in a contactless manner. An electrical sensor signal of the first sensor 40 is provided to a controller and processed there. By way of example, it may be provided that the sensor signal of the first sensor 40 is used to adjust the conveying movements of the feed device 5.

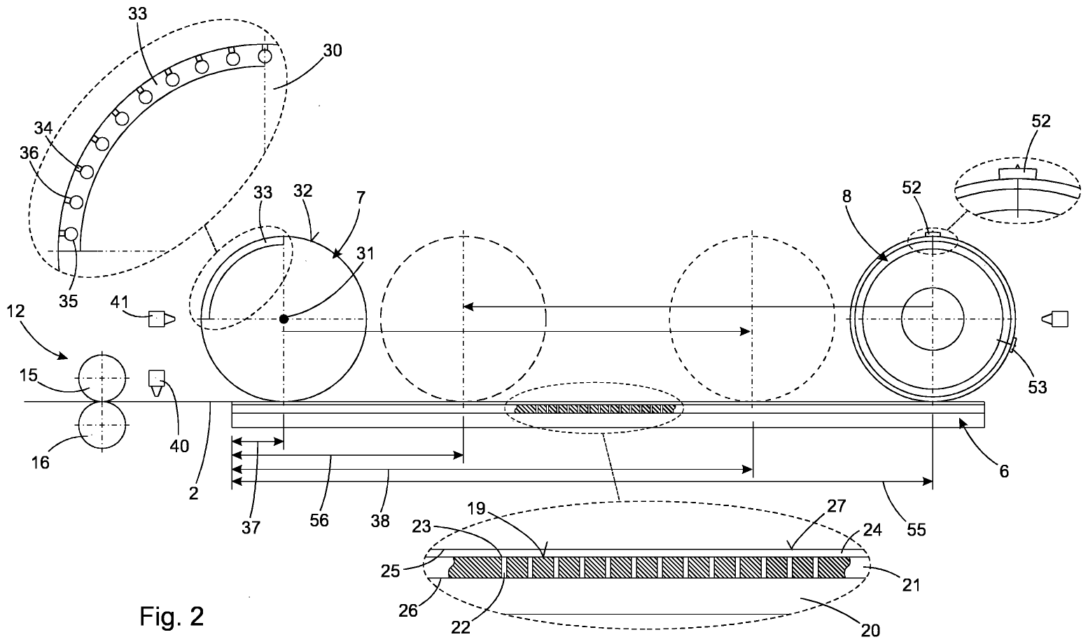

The anvil plate 6 has a purely exemplary flat working surface which is aligned transversely to the plane of representation of FIG. 1 and on which the film web 2 is laid out for carrying out the processing steps described in more detail below. As can be seen from the illustration of FIG. 2, the anvil plate 6 comprises a dimensionally stable carrier plate which is designed, by way of example, as a plane-parallel plate and which can be connected, by way of example, to the machine frame, which is not shown, in a manner not shown in greater detail. A work plate 21, which is likewise designed purely exemplarily as a plane-parallel plate, is attached to the carrier plate 20 and, according to the detailed representation of FIG. 2, is partially penetrated by fluid channels 22. Mouth openings 23 of the fluid channels 22 open out at the working surface 19, whereby, when the fluid channels 22 are subjected to negative pressure via a channel system formed in the working plate 21, which is not shown and which is connected to a negative pressure supply, which is not shown and which is arranged away from the anvil plate 6, negative pressure adhesion of the film web 2 to the working surface 19 in the region of the fluid channels 22 can be effected.

Purely by way of example, it is provided that the working surface 19 is provided on both sides with bearing strips 24 which project in a raised manner above the working surface 19 and whose longest edge 25 is aligned parallel to a longest edge of the anvil plate 6. In a cross-sectional plane oriented transversely to the longest edge 25, the bearing strips 24 may have a rectangular cross-section or a cross-section in the form of a right-angled trapezoid with an upper side sloping in the direction of the respective opposite bearing strips 24. The task of the bearing strips 24 consists in particular in forming, with their upper side 27 facing away from the working surface 19, a supporting surface for the cutting unit 8 described in more detail below.

The conveyor 7 is designed purely exemplarily as a transport cylinder 30. A transport cylinder axis 31 extends transversely to the plane of representation of FIGS. 1 and 2 and FIGS. 4 to 9 and at the same time forms the axis of rotational symmetry for the transport cylinder 30, which has a circular cylindrical profile. The transport cylinder 30 is provided with an intake area 33, shown only schematically in FIGS. 1 and 4 to 9, which extends over an angle of 90 degrees over a circumferential surface 32 in a purely exemplary manner. The intake area 33 is formed by a plurality of bores 34 shown purely schematically in detail in FIG. 2, the bores 34 being connected to vacuum channels 35 aligned parallel to the transport cylinder axis 31. The vacuum channels 35 can be connected in fluidic communication with a vacuum supply, also not shown, via a rotary union not shown, so that a vacuum can be provided at mouth openings 36 of the bores 34 in order to suck in the film web 2.

The transport cylinder 30 can be moved in various ways relative to the anvil plate 6. For example, a drive for the transport cylinder 30 that is not shown comprises a combination of a linear drive for a linear movement of the transport cylinder in the conveying direction 17 and against the conveying direction 17 and a rotary drive for a rotation of the transport cylinder 30 about the transport cylinder axis 31. With such a drive, the transport cylinder 30 can perform a pure linear movement, a pure rotational movement or a superposition of a linear movement and a rotational movement. In this case, the transport cylinder 30 can be moved from the first conveying position shown in FIG. 2, in which there is a first, minimum distance 37 of the transport cylinder 30 from the front edge 18 of the anvil plate 6, to a second conveying position, in which there is a second, maximum distance of the transport cylinder 30 from the front edge 18 of the anvil plate 6. During a linear movement of the transport cylinder 30 from the first conveying position towards the second conveying position, as well as during a linear movement of the transport cylinder 30 from the second conveying position towards the first conveying position, a rotation of the transport cylinder 30 may optionally be performed or not. The transport cylinder 30 may also perform an exclusive rotational movement in any position between the first conveying position and the second conveying position, but particularly in the first conveying position.

In a purely exemplary manner, the cutting unit 8 is designed as a cutting cylinder 50 which is equipped with a first cutting edge 52 and a second cutting edge 53 on a circular cylindrical outer surface 51. The first cutting edge 52 extends over a total width of the cutting cylinder 50 and is used to make a cross-cut 54 on the film web 2, as shown schematically in FIG. 3. The second cutting edge 53 is a shaping cutting edge and serves to produce the cutouts 3 in the film web 2, as this is shown schematically in FIG. 3.

The cutting cylinder 50 is moved by a drive not shown between a rest position, in which the cutting cylinder 50 is at a third, maximum distance 55 from the front edge 18 of the anvil plate 6, and a working position, in which the cutting cylinder 50 is at a fourth, minimum distance 56 from the front edge 18. Purely exemplarily, it is provided that the drive is designed in such a way that there is always a forced coupling between a rotational movement about a cutting cylinder axis 57 and a translational movement parallel to the conveying direction 17 for the cutting cylinder 50. Preferably, it is provided that the drive and the cutting cylinder 50 are matched to each other in such a way that the cutting cylinder performs a slip-free rolling movement on the bearing strips 24 with its outer surface 51.

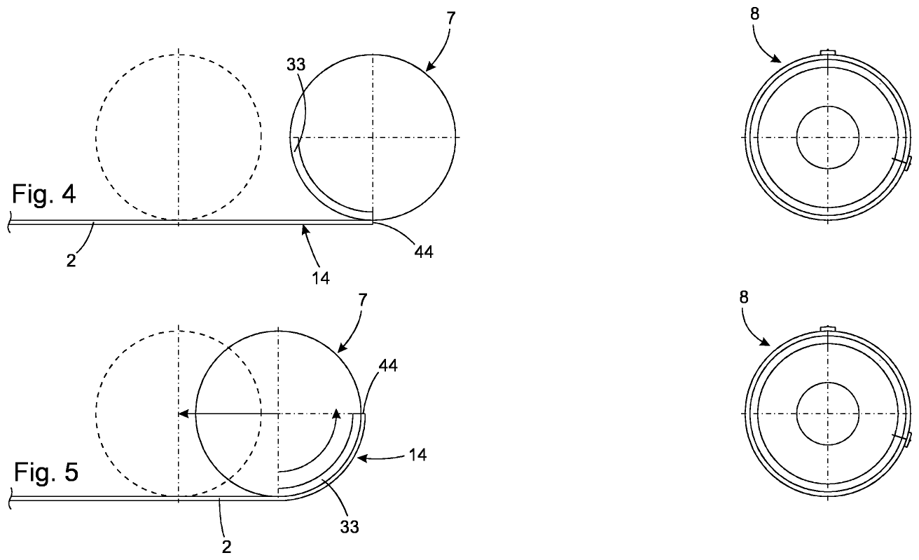

FIGS. 4 to 9 show, purely schematically, a sequence for processing an end region 14 of the film web 2. First of all, according to the illustration of FIG. 4, it is assumed that an end region 14 of the film web 2 rests on the anvil plate 6 at least over a certain length, which has been omitted in the illustrations of FIGS. 4 to 9 for reasons of clarity.

In a first step, the transport cylinder 30 is positioned by a superposition of a rotational movement and a translational movement in such a way that the suction area 33 is arranged above the end region 14. Purely exemplarily, the transport cylinder 30 is arranged in such a way that the suction area 33 ends with a front edge 44 of the end area 14 of the film web 2. As soon as the transport cylinder 30 assumes this position, an activation of the negative pressure supply can take place, so that a negative pressure is provided at the mouth openings 36 of the bores 34, with which a two-dimensional suction of the end region 14 to the circumferential surface 32 of the transport cylinder 30 takes place.

In a second step, as shown in FIG. 5, a rolling movement of the transport cylinder 30 onto the end region 14 of the film web 2 takes place with a counterclockwise direction of rotation in order to start a winding process for the end region 14 onto the transport cylinder 30. The rolling motion for the transport cylinder 30 is caused by a coordinated superposition motion between a rotation and a translation for the transport cylinder 30 by the drive means, reducing a distance of the transport cylinder 30 from the leading edge 18.

In a third step, as shown in FIG. 6, the transport cylinder 30 has reached the first conveying position and assumes the first, minimum distance 37 to the front edge 18. In this first conveying position, a scanning of the circumferential surface 32 of the transport cylinder 30 is performed by a second sensor 41, which is mounted in an unspecified manner on the machine frame of the separator 1 and which is designed to detect the leading edge 44 of the end region 14 of the film web 2. If the second sensor 41 is unable to detect the leading edge 44, a corresponding sensor signal is provided to the controller, which performs a control of the drive for the transport cylinder 30 in such a way that a purely rotational movement of the transport cylinder 30 is performed in the direction of the arrow according to the representation of FIG. 6, which is oriented counterclockwise purely by way of example, in order to effect a continuation of the winding process for the film web onto the transport cylinder 30. As soon as the second sensor 41 can detect the leading edge 44, it is assumed that a predetermined length of the film web 2 has been wound onto the transport cylinder 30, thus completing the third step.

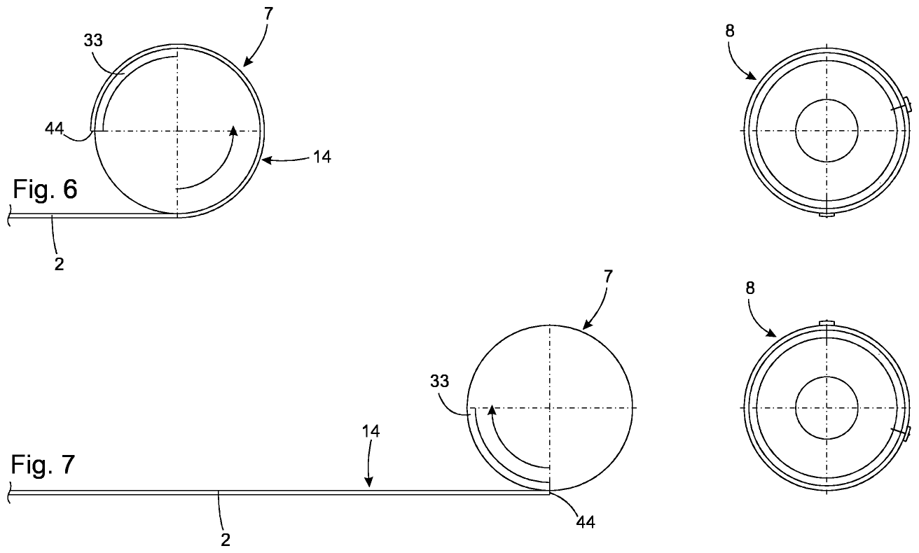

In a fourth step, as shown in FIG. 7, a pure rolling movement of the transport cylinder 30 takes place for laying out the film web 2 on the working surface of the anvil plate, which is not shown. This rolling motion is a synchronized superposition of a rotational motion and a translational motion of the transport cylinder 30 by the drive.

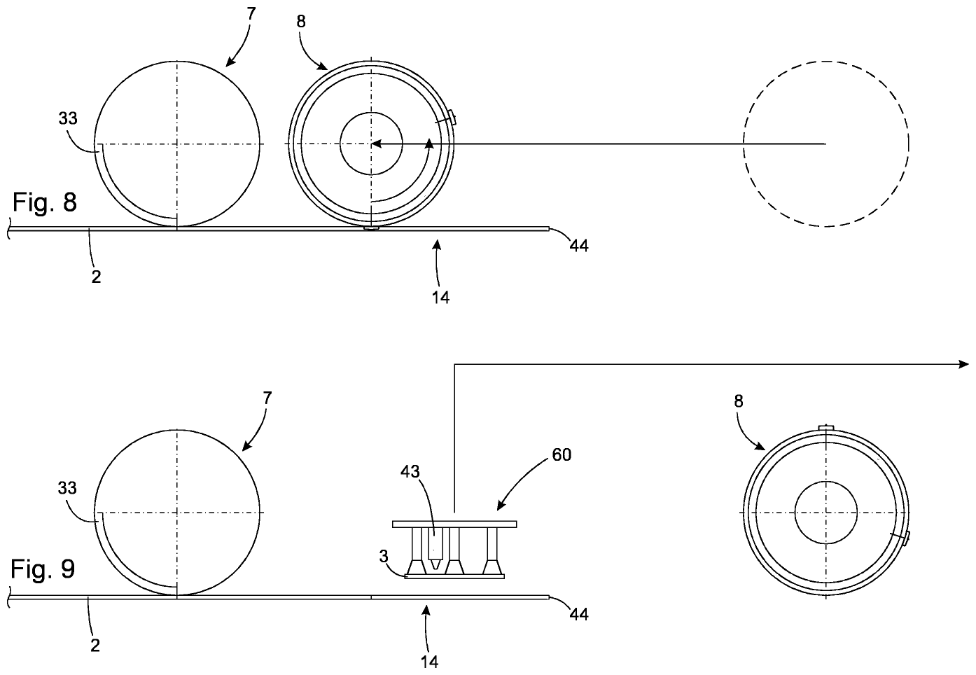

In a fifth step, as shown in FIG. 8, the cutting cylinder is transferred from the rest position to the working position, whereby the distance of the cutting cylinder 50 relative to the front edge 18 is reduced. In this connection, it is provided that a slip-free unrolling movement of the outer surface 51 of the cutting cylinder 50 on the bearing strips 24 is effected by means of the drive for the cutting cylinder which is not shown, the cutting edges 52 and 53 effecting the desired cutting operations for the end region 14 of the film web 2. At the beginning of the execution of the unwinding movement, a third sensor 42 can be used to check whether the cutting edge 53 is arranged in the correct rotational position. Insofar as the third sensor 42 should provide a sensor signal to the controller, which is not shown, indicating that the cutting edge 53 is not correctly positioned, provision can be made, for example, for switching off the separator 1 and for issuing a warning message. Alternatively, if the drive for the cutting cylinder 50 is suitably designed, an adjustment operation may be provided by exclusively rotating the cutting cylinder 50 until the cutting edge 53 assumes the desired position.

In a sixth step, as shown in FIG. 9, the cutout 3, which has been separated from the film web 2 by the cutting cylinder 50, is picked up by a gripper 60, which can be designed in particular as a vacuum gripper and which can deposit the cutout 3 away from the separator 1 in a suitable magazine. The gripper 60 can be equipped with a fourth sensor 43, which is designed to perform a quality control for the cutout 3 and to qualify it as a good part or a bad part by applying predetermined criteria. An evaluation of a sensor signal from the third sensor 42 can be performed, for example, in an evaluation device, which then provides a control signal for the gripper 60 to either feed the cutout 3 to a downstream processing step or to dispose of the cutout 3 as a reject. The gripper 60 may include one or more fluid channels connected to a common vacuum supply, which may be controlled by a common valve means or by separate valve means. This may realize, for example, selective gripping and/or depositing or dropping of the cutout 3 and a waste grid with the gripper 60. Furthermore, a further gripper, not shown, can be provided which transports a residual piece of the end region 14 of the film web 2 remaining after removal of the cutout 3, which is also referred to as a waste grid, away from the separator 1.

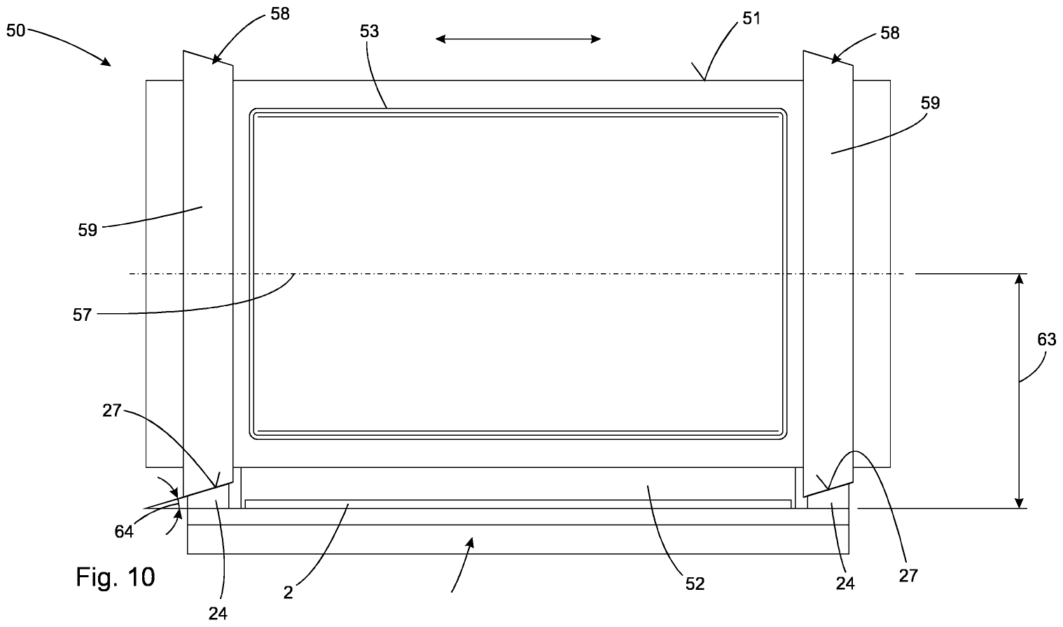

The cutting cylinder 50 shown in FIG. 10, like the anvil plate 6, is shown only schematically and in no way to scale. Purely exemplarily, the first cutting edge 52 arranged on the outer surface 51 of the cutting cylinder 50 extends almost over the entire width of the cutting cylinder 50 and is purely exemplarily in cutting engagement with the end region 14 of the film web 2. The second cutting edge 53 is designed purely exemplarily as a closed circumferential cutting edge for cutting out a rectangular section 3 from the film web 2. Furthermore, bearing rings 58 are arranged on the outer surface 51 of the cutting cylinder 50 in each case in the form of conical sections, the conical surfaces 59 of which are aligned at an acute angle 64 to the working surface 19. During a relative movement of the cutting cylinder 50 along the anvil plate 6, the bearing rings 58 perform a slip-free rolling movement on the bearing strips 24, which are each arranged on both sides at the edge of the working surface 19 and which have a profiling in the manner of a right-angled trapezoid. The upper surfaces 27 of the bearing strips 24 assume the same acute angle 64 to the working surface 19 as the conical surfaces 59 of the bearing rings 58. Accordingly, a distance 63 between the cutting cylinder axis 57 and the work surface 19 can be adjusted by linear displacement of the cutting cylinder 50 along the cutting cylinder axis 57.

In an embodiment of the anvil plate and/or the cutting cylinder, recesses are arranged in the respective surfaces which are designed to temporarily receive components projecting from the film web in a raised manner, such as electronic components integrated in the film web, or that the recesses in the anvil plate 6 are arranged such that a cutting edge is formed in the anvil plate 6 itself which acts as a counter cutting edge to at least one of the cutting edges 52, 53 on the cutting cylinder 50.

1-13. (canceled)

14. A separator for separating a film web region by region, comprising:
an anvil plate which has a working surface for laying out an end region of a film web,
a conveyor linearly moveable with respect to the anvil plate along a conveying axis to carry out a laying-out movement for the end region of the film web, which laying-out movement is aligned parallel to the working surface,
a cutting unit which has at least one cutting edge for carrying out a separating operation on the end region of the film web which is received between the cutting edge and the working surface, wherein the conveyor and the cutting unit carry out the lay out movement and the separating operation for the end region of the film web.

15. The separator according to claim 14, wherein the conveyor is moveable between a first conveying position with a first, minimum distance relative to a front edge of the anvil plate aligned transversely to the conveying axis and a second conveying position with a second, maximum distance relative to the front edge of the anvil plate, and wherein the cutting unit is moveable between a rest position with a third, maximum distance relative to the front edge and a working position with a fourth, minimum working distance relative to the front edge.

16. The separator according to claim 15, wherein the conveyor comprises a transport cylinder having a transport cylinder axis which is aligned transversely to the conveying axis and parallel to the working surface to carry out the conveying operation with a linear movement along the conveying axis and/or with a rotational movement about the transport cylinder axis.

17. The separator according to claim 16, wherein the cutting unit comprises a cutting cylinder having a cutting cylinder axis aligned transversely to the conveying axis and parallel to the working surface to carry out the separating operation with a superimposition of a linear movement along the conveying axis and a rotational movement about the cutting cylinder axis, the at least one cutting edge being attached to an outer surface of the cutting cylinder.

18. The separator according to claim 17, wherein the working surface has a planar bearing region for the end region of the film web and wherein bearing strips which adjoin the bearing region on both sides, extend along the conveying axis and project in a raised manner from the bearing region, and wherein the cutting cylinder rests with an outer surface on the bearing strips at least in regions when the movement between the rest position and the working position is carried out.

19. The separator according to claim 16, wherein the transport cylinder is assigned a sensor for detecting a front edge of the end region of the film web and/or wherein the cutting cylinder is assigned a sensor for detecting a position of the cutting edge, and/or wherein a sensor for detecting properties of the film web is arranged in the region of the front edge of the anvil plate.

20. The separator according to claim 14, wherein at least one mouth opening of a fluid channel is formed on the working surface and/or on an outer surface of the conveyor and/or on an outer surface of the cutting unit.

21. The separator according to claim 14, wherein the at least one cutting edge of the cutting unit and the working surface of the anvil plate allow a separating operation for the end region of the film web from the group: transverse cutting of the film web, cutting out of film cutouts from the film web, crush cutting, lifting punching, shear cutting.

22. The separator according to claim 14, wherein the cutting unit is a lifting punch for carrying out a lifting punching movement aligned transversely to the working surface of the anvil plate and is mounted so as to be linearly movable with respect to the anvil plate between a rest position at a distance which is greater than an extension of the conveyor transversely to the working surface and a working position at a disappearing distance from the working surface.

23. The separator according to claim 14, wherein a gripper is arranged on the anvil plate so as to be relatively movable for a removal of good parts into defined deposit position and/or for a removal of waste.

24. A separator for separating a film web region by region, comprising:
an anvil plate with a working surface for laying out a film web,
a conveyor for conveying the film web along a conveying axis which is aligned parallel to the working surface,
a cutting cylinder which is movable parallel to the working surface and which has at least one cutting edge for carrying out a cutting operation for the film web received between the cutting edge and the working surface,
wherein bearing strips are arranged at edges of the working surface, each of the bearing strips being aligned with a longest edge parallel to the conveying axis, which bearing strips have upper sides aligned parallel to one another and at an acute angle to the working surface, and
wherein the cutting cylinder has two cone sections on an outer circumferential surface which are aligned at an acute angle to a cutting cylinder axis to rest on the upper sides of the bearing strips, wherein an adjusting unit for positioning the cutting cylinder along the cutting cylinder axis is located between the anvil plate and the cutting cylinder.

25. A method for cutting a film web region by region, comprising the steps:
detecting an end region of a film web laid out on a working surface of an anvil plate with a transport cylinder,
performing a first winding movement for the end region of the film web onto the transport cylinder during a first linear retracting movement of the transport cylinder,
detecting an end edge of the end region of the film web, which end edge is arranged on the transport cylinder, with a sensor, and
controlling a second rewinding movement for the transport cylinder at a first conveying position at which the transport cylinder has a first, minimum distance from a first end region of the anvil plate,
performing a combination of an unwinding movement and a second linear advancing movement for the transport cylinder along the working surface of the anvil plate for depositing the end region of the film web on the working surface, and
performing a second linear retracting movement of the transport cylinder to the first conveying position,
performing a combination of an unwinding movement and a third linear advancing movement for a cutting cylinder along the working surface of the anvil plate between a rest position with maximum distance from the first end region of the anvil plate and a working position with minimum distance from the first end region of the anvil plate,
wherein a cutting edge of the cutting cylinder performs a cutting operation for an end region of the film web received between the cutting edge and the working surface, and gripping and transporting away a portion of the end region of the film web cut from the cutting edge by means of a gripping device mounted movably on the anvil plate.

26. The method according to claim 25, wherein the end region of a film web is gripped by the transport cylinder to make a first linear feed movement for the transport cylinder along a working surface of the anvil plate for laying out the end region of the film web on the working surface.
